(19) United States
(12) Patent Application Publication
(10) Pub. No.: US 2018/0157733 A1
(43) Pub. Date: Jun. 7, 2018

(54) SYSTEMS AND METHODS FOR GENERATING CONTENT

(71) Applicant: Facebook, Inc., Menlo Park, CA (US)

(72) Inventor: Weiyi Liu, Sunnyvale, CA (US)

(21) Appl. No.: 15/370,188

(22) Filed: Dec. 6, 2016

(51) Int. Cl. G06F 17/30

(52) U.S. Cl. CPC G06F 17/30598; G06F 17/3089; G06F 17/30867

(57) ABSTRACT

Systems, methods, and non-transitory computer-readable media can determine a set of content sources that post content items relating to a first topic. One or more content items that were posted by at least one content source in the set of content sources are be determined. An interface that references at least one topic channel corresponding to the first topic through which the one or more content items are accessible is provided.

### FIELD OF THE INVENTION

The present technology relates to the field of content provision. More particularly, the present technology relates to techniques for generating content for users.

### BACKGROUND

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

Under conventional approaches, users may post various content items to the social networking system. In general, content items posted by a first user can be included in the respective content feeds of other users of the social networking system, for example, that have “followed” the first user. By following (or subscribing to) the first user, some or all content that is produced, or posted, by the first user may be included in the respective content feeds of the following users. A user following the first user can simply unfollow the first user to prevent new content that is produced by the first user from being included in the following user's content feed.

### SUMMARY

Various embodiments of the present disclosure can include systems, methods, and non-transitory computer readable media configured to determine a set of content sources that post content items relating to a first topic. One or more content items that were posted by at least one content source in the set of content sources are be determined. An interface that references at least one topic channel corresponding to the first topic through which the one or more content items are accessible is provided.

In some embodiments, the set of content sources are selected by one or more curators.

In some embodiments, the systems, methods, and non-transitory computer readable media are configured to cluster a plurality of content sources into one or more topic clusters and determine the set of content sources from a topic cluster that corresponds to the first topic.

In some embodiments, a content source that posts a threshold amount of content items having at least one term that corresponds to the first topic is included in a topic cluster that corresponds to the first topic.

In some embodiments, the systems, methods, and non-transitory computer readable media are configured to determine a subset of content sources from the topic cluster using content sources that were selected from the topic cluster by one or more curators.

In some embodiments, the one or more content items are selected by one or more curators.

In some embodiments, the systems, methods, and non-transitory computer readable media are configured to determine that a quality of a content item satisfies a content quality threshold.

In some embodiments, the quality of the content item is based at least in part on one or more of a number of likes received for the content item, a number of times the content item was shared with other users, a number of comments that were posted in response to the content item, a number of users following a content source that posted the content item, a number of users that accessed the content item, an average amount of time spent by users viewing the content item, whether the content item is trending in popularity among users, a video quality of the content item, or a sound quality of the content item.

In some embodiments, the systems, methods, and non-transitory computer readable media are configured to determine that a user accessing the interface is interested in the first topic.

In some embodiments, the systems, methods, and non-transitory computer readable media are configured to determine that a user account of the user is following a content source that is associated with the first topic.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content provider module, according to an embodiment of the present disclosure.

FIG. 2 illustrates an example content channel module, according to an embodiment of the present disclosure.

FIG. 3 illustrates an example interface, according to an embodiment of the present disclosure.

FIG. 4 illustrates another example interface, according to an embodiment of the present disclosure.

FIG. 5 illustrates an example method for generating topic channels, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Generating Content

People often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

Under conventional approaches, users may post various content items to the social networking system. In general, content items posted by a first user can be included in the respective content feeds of other users of the social networking system that have “followed” the first user. By following (or subscribing to) the first user, some or all content that is produced, or posted, by the first user may be included in the respective content feeds of the users following the first user. A user following the first user can prevent new content from the first user from being included in the user's content feed by simply “unfollowing” the first user.

In some instances, users can access topic channels (or streams) that correspond to various topics. A topic channel corresponding to a particular topic may include various types of content items that each have been determined to be relevant, or related, to that topic. In general, the content items included in a topic channel can be posted by various users of the social networking system. These topic channels can be updated regularly to include newly posted content items that are relevant. As a result, a topic channel can provide a continuous stream of content items related to a given topic for the user to browse. Under conventional approaches, content items to be included in a topic channel can be determined manually by curators that individually identify content sources from which content items can manually be selected for inclusion in the topic channel. However, this manual approach may not be optimal given the large number of content sources and/or content items that may be available in the social networking system at any given time. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In some embodiments, content items to be included in a topic channel may be determined using a hybrid approach that involves the use of one or more algorithms to automatically select content sources (e.g., user accounts that post various content items) and then selecting content items from those content sources for inclusion in the relevant topic channels. In some embodiments, the selection of content items is done automatically using one or more algorithms. In some embodiments, the selection of content items is done manually by one or more curators. In some embodiments, content items to be included in a topic channel may be determined using a different hybrid approach that involves the use of one or more curators to select content sources (e.g., user accounts that post various content items) and using one or more algorithms to automatically select content items from those content sources for inclusion in the relevant topic channels.

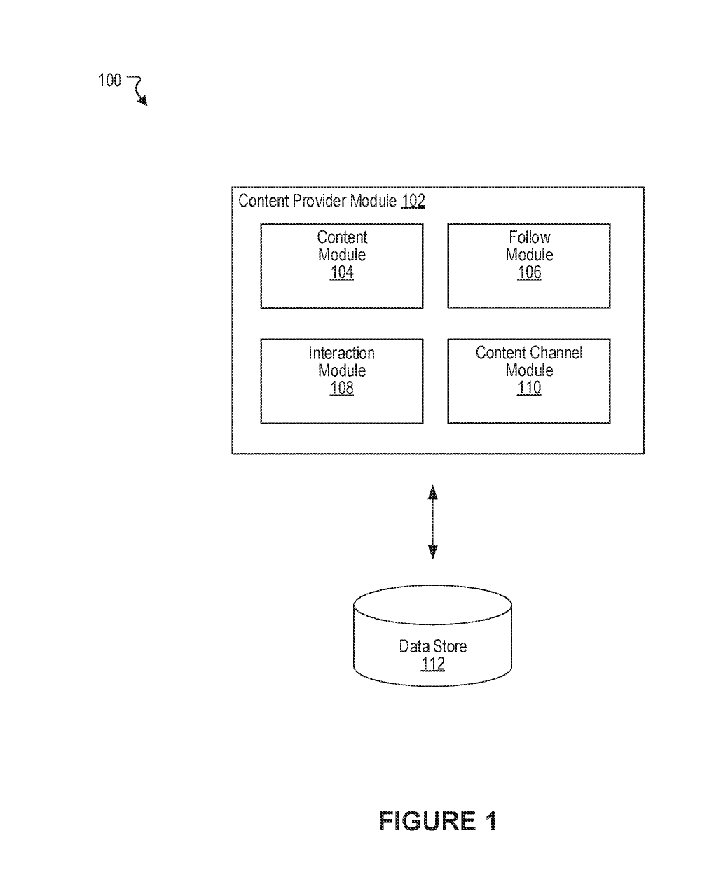

FIG. 1 illustrates an example system 100 including an example content provider module 102, according to an embodiment of the present disclosure. As shown in the example of FIG. 1, the content provider module 102 can include a content module 104, a follow module 106, an interaction module 108, and a content channel module 110. In some instances, the example system 100 can include at least one data store 112. The components (e.g., modules, elements, etc.) shown in this figure and all figures herein are exemplary only, and other implementations may include additional, fewer, integrated, or different components. Some components may not be shown so as not to obscure relevant details.

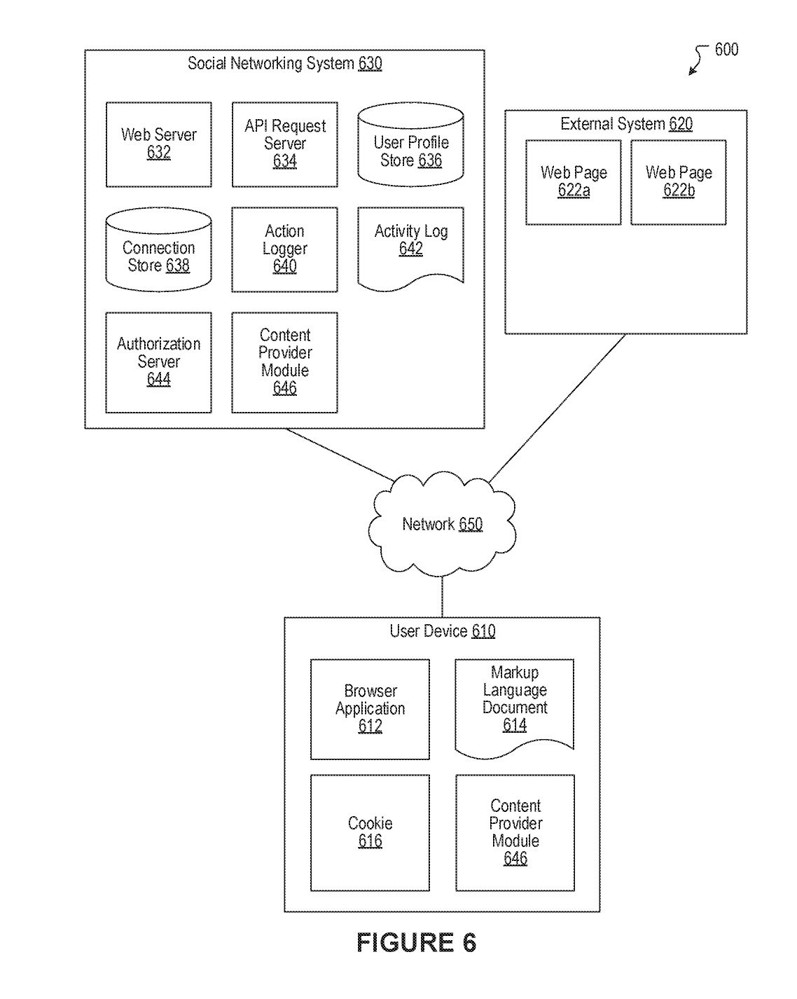

In some embodiments, the content provider module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content provider module 102 can be implemented, in part or in whole, as software running on one or more computing devices or systems, such as on a user or client computing device. In one example, the content provider module 102 or at least a portion thereof can be implemented as or within an application (e.g., app), a program, or an applet, etc., running on a user computing device or a client computing system, such as the user device 610 of FIG. 6. In another example, the content provider module 102 or at least a portion thereof can be implemented using one or more computing devices or systems that include one or more servers, such as network servers or cloud servers. In some instances, the content provider module 102 can, in part or in whole, be implemented within or configured to operate in conjunction with a social networking system (or service), such as the social networking system 630 of FIG. 6.

The content provider module 102 can be configured to communicate and/or operate with the at least one data store 112, as shown in the example system 100. The at least one data store 112 can be configured to store and maintain various types of data. For example, the data store 112 can store information describing various content that has been posted by users of a social networking system. In some implementations, the at least one data store 112 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 112 can store information associated with users, such as user identifiers, user information, profile information, user specified settings, content produced or posted by users, and various other types of user data.

The content provider module 102 can be configured to provide users with access to content that is posted through a social networking system. For example, the content module 104 can provide a first user with access to content items through an interface that is provided by a software application (e.g., a social networking application) running on a computing device of the first user. The first user can also interact with the interface to post content items to the social networking system. Such content items may include text, images, audio, and videos, for example.

In various embodiments, other users of the social networking system can access content items posted by the first user. In one example, the other users can access the content items by searching for the first user through the interface, for example, by user name. In some instances, some users may want to see content items posted by the first user in their respective content feed. To cause content items posted by the first user to be included in their respective content feed, a user can select an option through the interface to subscribe to, or “follow”, the first user. The follow module 106 can process the user's request by identifying the user as a follower of (or “friend” of) the first user in the social networking system. As a result, some or all content items that are posted by the first user can automatically be included in the respective content feed of the user. If the user decides that they no longer want to see content from the first user in their respective content feed, the user can select an option through the interface to “unfollow” the first user. As a result, the follow module 106 can remove the association between the user and the first user so that content items posted by the first user are no longer included in the content feed of the user. In some instances, the user may want to endorse, or “like”, a content item. In such instances, the user can select an option provided in the interface to like the desired content item. The interaction module 108 can determine when a user likes a given content item and can store information describing this relationship. In some embodiments, information describing user interactions can be stored in a social graph as described in reference to FIG. 6. In some embodiments, the interaction module 108 can determine when a user shares a given content item and can store information describing the content item that was shared and with which users the content item was shared. In some instances, the user may want to post a comment in response to a content item. In such instances, the user can select an option provided in the interface to post a comment in response to the desired content item. The interaction module 108 can determine when a user posts comments for a given content item and can store information describing this relationship.

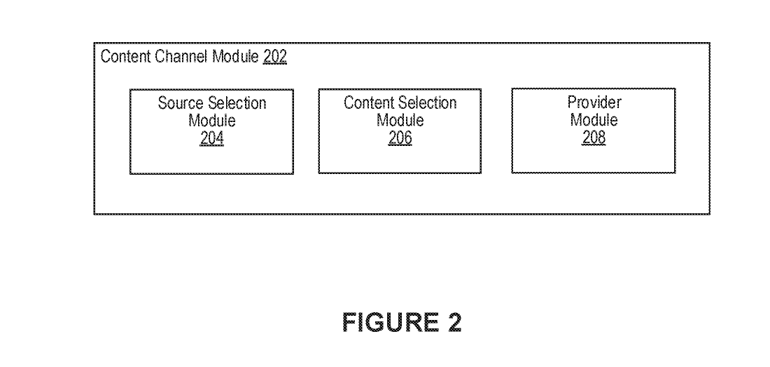

In addition to their respective content feeds, in some embodiments, users can also access topic channels that correspond to various topics (e.g., baking, motorcycles, funny, cats, etc.). A topic channel corresponding to a particular topic may include various types of content items that each have been determined to be relevant, or related, to that topic. In general, the content items included in a topic channel can be posted by various users of the social networking system. In various embodiments, the content channel module 110 is configured to generate and update topic channels using content items that are available from various sources including, for example, any content items that are posted through the social networking system. More details regarding the content channel module 110 will be provided below with reference to FIG. 2.

FIG. 2 illustrates a content channel module 202, according to an embodiment of the present disclosure. In some embodiments, the content channel module 110 of FIG. 1 can be implemented with the content channel module 202. As shown in the example of FIG. 2, the content channel module 202 can include a source selection module 204, a content selection module 206, and a provider module 208.

As mentioned, users of the social networking system can access topic channels (or streams) that correspond to various topics. In general, a topic channel includes relevant content items that were posted by various content sources. The content sources to be used for populating a topic channel can be selected manually or automatically. For example, in some embodiments, when generating a topic channel, the source selection module 204 can provide an interface through which human curators can manually specify content sources to be used for populating a topic channel. Thus, for example, when selecting content sources for a “fishing” topic channel, a human curator can simply select the content sources that are related to “fishing”. Some or all of the content items posted by these content sources can then be included in the “fishing” topic channel.

In some embodiments, when generating a topic channel, the source selection module 204 can automatically select content sources (e.g., user accounts that post various content items) that relate to the topic based on one or more algorithms. For example, in some embodiments, the source selection module 204 clusters content sources into respective topic clusters. Each topic cluster can include one or more content sources that post content items relating to the topic. For example, in some embodiments, when assigning a content source to a topic cluster, the source selection module 204 can determine whether a threshold amount (e.g., number, percentage, etc.) of content items posted by the content source included at least one term (e.g., keyword, hashtag, etc.) that corresponds to the topic. For example, a content source may often post content items with the hashtag “fashion”. In this example, if a threshold amount of content items are posted by the content source with the hashtag “fashion”, then the content source can be assigned to a topic cluster corresponding to “fashion”. In some embodiments, a content source may be assigned to one or more topic clusters based on co-follower data. For example, the source selection module 204 may determine that a threshold amount of users that follow a first content source that is known to correspond to a first topic cluster also follow a second content source. In this example, the source selection module 204 can assign the second content source to the first topic cluster based on the co-follower data. In some embodiments, a content source may be assigned to one or more topic clusters based on user co-interaction data. For example, the source selection module 204 may determine that a threshold amount of users that interacted (e.g., liked, shared, commented) with content items posted by a first content source that corresponds to a first topic cluster also interacted with content items posted by a second content source. In this example, the source selection module 204 can assign the second content source to the first topic cluster based on the co-interaction data. These approaches to clustering are provided as examples and, naturally, any generally known technique for clustering content into topic clusters may be utilized. When selecting content sources for populating a topic channel, the source selection module 204 can simply select content sources from the corresponding topic cluster. For example, when selecting content sources for a “fishing” topic channel, the source selection module 204 can determine which content sources are included in the topic cluster that corresponds to “fishing”. Some or all of the content items posted by these content sources can then be included in the “fishing” topic channel. In some embodiments, the source selection module 204 can automatically generate tags (e.g., hash tags) for content items based on at least the subject matter reflected in the content items. These tags can be utilized when assigning content sources to topic clusters as described above. In some embodiments, auto-generated tags that describe a content item can be used to inform a topic cluster of a content source. In various embodiments, the source selection module 204 can automatically generate tags for a content item by analyzing the subject matter of the content item, for example, using trained machine learning model (content classifier). In particular, the source selection module 204 can determine a probability regarding whether a given content item reflects predetermined subject matter (e.g., identities, or names, of individuals, objects, activities, products, logos, animals, points of interest, or other concepts). The content classifier can be based on any machine learning technique, including but not limited to a deep convolutional neural network. The content classifier supported by the source selection module 204 can be trained and tested to determine the subject matter reflected in a content item. In a development phase, contextual cues for a sample set of content items can be gathered. Content classes corresponding to various subject matter can be determined. Correlation of the sample set of content items with the content classes based on the contextual cues can be determined. A training set of content items can be generated from the sample set of content items based on scores indicative of high correlation. The training set of content items can be used to train the content classifier to generate visual pattern templates of the content classes. In an evaluation phase, the content classifier can be applied to a new content item to determine the subject matter reflected in the new content item. In some embodiments, upon processing an input content item, the content classifier outputs a set of features that correspond to the subject matter reflected in the inputted content item. For each feature, the content classifier can also output a respective probability indicating a likelihood that the feature was found in the subject matter reflected by the inputted content item. In some embodiments, features that satisfy predetermined thresholds can be used to tag the inputted content item.

In some embodiments, the content sources included in a topic cluster can be filtered to produce a subset of content sources that will be used to provide content for a topic channel. For example, in some embodiments, the source selection module 204 provides an interface through which human curators can manually identify content sources from the topic clusters to be used for the topic channel. In general, the curators can select the content sources that regularly post content items that relate to the topic and that also satisfy some measure of quality. In some embodiments, the source selection module 204 automatically identifies content sources from the topic cluster to be used for the topic channel. For example, the source selection module 204 can select content sources that post a threshold amount (e.g., number, percentage, etc.) of content items that satisfy a content quality threshold. The quality of a content item may be measured based on myriad considerations. In some embodiments, the quality of a content item is measured based on one or more of a number of likes received for the content item, a number of times the content item was shared with other users, a number of comments that were posted in response to the content item, a number of users following a content source that posted the content item, a number of users that accessed the content item, an average amount of time spent by users viewing the content item, whether the content item is trending in popularity among users, the video quality of the content item, the sound quality of the content item, and/or an amount of time since the content item was posted, to name some examples. In some embodiments, the source selection module 204 can also select content sources based on a respective consistency between the content items that are posted by the content sources. For example, a content source in a topic cluster that consistently (e.g., every content item, every other content item, etc.) posts content items that satisfy a content quality threshold can be used to populate the topic channel.

The content selection module 206 can be used to select content items from the selected content sources (e.g., the subset of content sources) for inclusion in the topic channel. In some embodiments, the content selection module 206 provides an interface through which human curators can manually identify content items to be included in the topic channel. In some embodiments, the content selection module 206 automatically identifies content items to be included in the topic channel. For example, the source selection module 204 can select content items that satisfy a content quality threshold. In some embodiments, the quality of a content item may be measured based on some, or all, of the considerations described above.

In various embodiments, content items selected using the content selection module 206 (either manually or automatically) can be ordered, or ranked, so that the best content items can be presented through the topic channel. Depending on the implementation, a content item can be ranked based on a number of likes received for the content item, a number of times the content item was shared with other users, a number of comments that were posted in response to the content item, a number of users following a content source that posted the content item, a number of users that accessed the content item, an average amount of time spent by users viewing the content item, whether the content item is trending in popularity among users, the video quality of the content item, the sound quality of the content item, and/or an amount of time since the content item was posted, to name some examples. In some embodiments, the source selection module 204 can also select content sources based on a respective consistency between the content items that are posted by the content sources. For example, a content source that consistently posts content items that satisfy a content quality threshold (e.g., every content item, every other content item, every nth content item, etc.) can be selected over a content source that does not post quality content items as frequently.

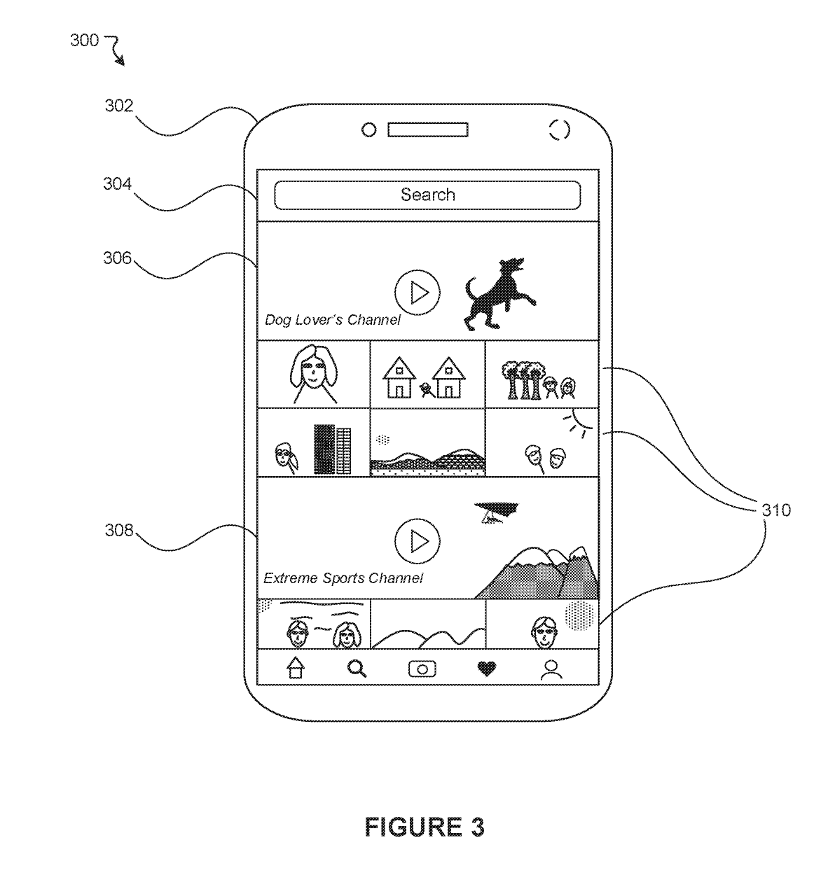

In some embodiments, the provider module 208 can determine a set of personalized topic channels to be presented to a user through an interface, as illustrated in the example of FIG. 3. In some embodiments, the provider module 208 can determine which topic channels to provide to a user based on any content sources that are being followed by the user. For example, the provider module 208 can determine that a user follows a user account of a pop musician. In this example, the provider module 208 can identify one or more topic channels (e.g., a pop music channel) based in part on the user following the popular musician. For example, the provider module 208 can map the user account of the pop musician (e.g., content source) to a topic cluster. The provider module 208 can then provide the topic channel that corresponds to that topic cluster. In some embodiments, the provider module 208 can determine which topic channels to provide to a user based on the user's historical interactions with content items. For example, the personalization module 208 can determine the user's tastes (or preferences) based on the types of content items the user accesses, likes, shares, or performs some other action that is indicative of the user being interested in the content item. The provider module 208 can then identify topic channels that include content items that correspond to the user's tastes.

FIG. 3 illustrates an example 300 of an interface 304, according to an embodiment of the present disclosure. In this example, the interface 304 is presented through a display screen of a computing device 302. Further, the interface 304 may be provided through an application (e.g., a web browser, a social networking application, messenger application, etc.) running on the computing device 302 that is configured to interact with a social networking system. The interface 304 includes a number of different options for accessing content through the social networking system. In this example, the interface 304 includes a region through which a user operating the computing device 302 can access a topic channel 306. The interface 304 also includes a region through which a user operating the computing device 302 can access a different topic channel 308. In some embodiments, the topic channel 306 (and/or the topic channel 308) begins playing content automatically in its corresponding region of the interface 304 as soon as the interface 304 is displayed.

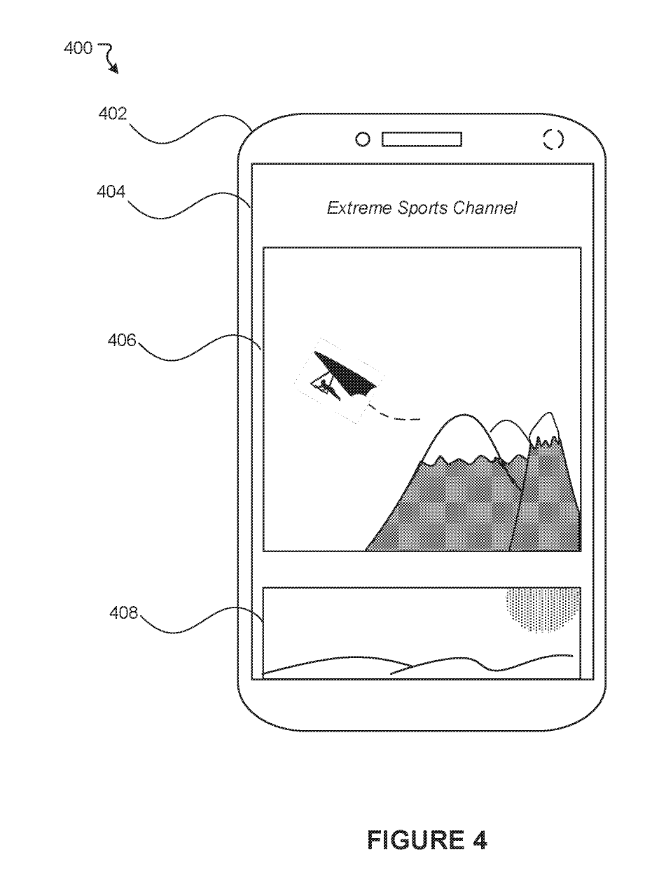

In some embodiments, the user operating the computing device 302 can dismiss a topic channel to signal that the topic channel is not of interest to the user. As a result, the dismissed topic channel will not be presented to the user in the future. In some embodiments, a topic channel can be dismissed, for example, by selecting an option or performing an appropriate gesture through the computing device 302. The interface 304 can also include one or more content items 310 that can be accessed through a grid of content items. The interface 304 is provided merely as an example and, naturally, many variations in the organization of content items and channels are possible. In addition to topic channels, in some embodiments, the interface 304 can include other types of channels such as personalized channels for the user, trending channels, and editorial channels, to name some examples. In some embodiments, upon selecting a topic channel, the software application can be configured to provide an immersive interface that presents content items that are included in the topic channel, as illustrated in the example of FIG. 4.

FIG. 4 illustrates an example 400 of an interface 404, according to an embodiment of the present disclosure. In this example, the interface 404 is presented through a display screen of a computing device 402. Further, the interface 404 may be provided through an application (e.g., a web browser, a social networking application, messenger application, etc.) running on the computing device 402 that is configured to interact with a social networking system. In this example, the interface 404 is an immersive interface that is being presented in response to a topic channel being selected, as described in reference to FIG. 3. The interface 404 presents content items that correspond to the selected topic channel. In this example, the interface 404 is presenting a content item 406. In some embodiments, the content items included in the topic channel can individually be presented through the interface 404. In some embodiments, a portion of the next content item 408 to be presented is shown in the interface 404.

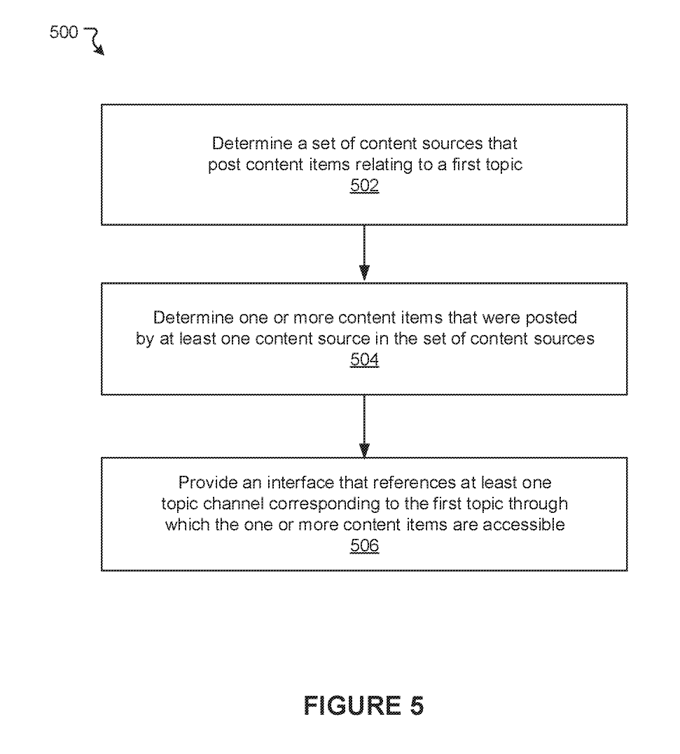

FIG. 5 illustrates an example method 500 for generating topic channels, according to an embodiment of the present disclosure. It should be appreciated that there can be additional, fewer, or alternative steps performed in similar or alternative orders, or in parallel, within the scope of the various embodiments discussed herein unless otherwise stated.

At block 502, a set of content sources that post content items relating to a first topic are determined. At block 504, one or more content items that were posted by at least one content source in the set of content sources are be determined. At block 506, an interface that references at least one topic channel corresponding to the first topic through which the one or more content items are accessible is provided.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content provider module 646. The content provider module 646 can, for example, be implemented as the content provider module 102 of FIG. 1. In some embodiments, the content provider module 646, in whole or in part, may be implemented in a user device 610 or the external system 620. As discussed previously, it should be appreciated that there can be many variations or other possibilities.

### Hardware Implementation

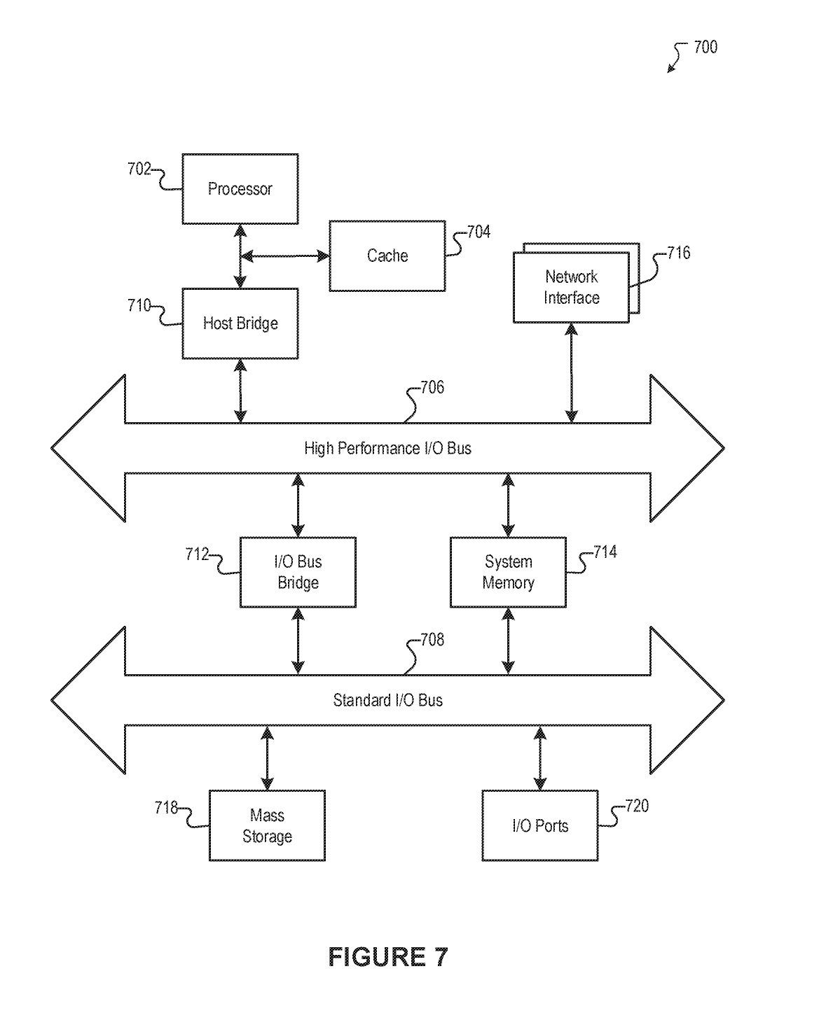

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, a set of content sources that post content items relating to a first topic;
determining, by the computing system, one or more content items that were posted by at least one content source in the set of content sources; and
providing, by the computing system, an interface that references at least one topic channel through which the one or more content items are accessible.

2. The computer-implemented method of claim 1, wherein the set of content sources are selected by one or more curators.

3. The computer-implemented method of claim 1, wherein determining the set of content sources that post content items relating to at least one topic further comprises:
clustering, by the computing system, a plurality of content sources into one or more topic clusters; and
determining, by the computing system, the set of content sources from a topic cluster that corresponds to the first topic.

4. The computer-implemented method of claim 3, wherein a content source that posts a threshold amount of content items having at least one term that corresponds to the first topic is included in a topic cluster that corresponds to the first topic.

5. The computer-implemented method of claim 3, wherein determining the set of content sources from the topic cluster that corresponds to the first topic further comprises:
determining, by the computing system, a subset of content sources from the topic cluster using content sources that were selected from the topic cluster by one or more curators.

6. The computer-implemented method of claim 1, wherein the one or more content items are selected by one or more curators.

7. The computer-implemented method of claim 1, wherein determining one or more content items that were posted by at least one content source in the set of content sources further comprises:
determining, by the computing system, that a quality of a content item satisfies a content quality threshold.

8. The computer-implemented method of claim 1, wherein the quality of the content item is based at least in part on one or more of a number of likes received for the content item, a number of times the content item was shared with other users, a number of comments that were posted in response to the content item, a number of users following a content source that posted the content item, a number of users that accessed the content item, an average amount of time spent by users viewing the content item, whether the content item is trending in popularity among users, a video quality of the content item, or a sound quality of the content item.

9. The computer-implemented method of claim 1, wherein providing the interface that references at least one topic channel through which the one or more content items are accessible further comprises:
determining, by the computing system, that a user accessing the interface is interested in the first topic.

10. The computer-implemented method of claim 1, wherein determining that the user accessing the interface is interested in the topic further comprises:
determining, by the computing system, that a user account of the user is following a content source that is associated with the first topic.

11. A system comprising:
at least one processor; and
a memory storing instructions that, when executed by the at least one processor, cause the system to perform:
determining a set of content sources that post content items relating to a first topic;
determining one or more content items that were posted by at least one content source in the set of content sources; and
providing an interface that references at least one topic channel corresponding to the first topic through which the one or more content items are accessible.

12. The system of claim 11, wherein the set of content sources are selected by one or more curators.

13. The system of claim 11, wherein determining the set of content sources that post content items relating to at least one topic further causes the system to perform:
clustering a plurality of content sources into one or more topic clusters; and
determining the set of content sources from a topic cluster that corresponds to the first topic.

14. The system of claim 13, wherein a content source that posts a threshold amount of content items having at least one term that corresponds to the first topic is included in a topic cluster that corresponds to the first topic.

15. The system of claim 13, wherein determining the set of content sources from the topic cluster that corresponds to the first topic further causes the system to perform:
determining a subset of content sources from the topic cluster using content sources that were selected from the topic cluster by one or more curators.

16. A non-transitory computer-readable storage medium including instructions that, when executed by at least one processor of a computing system, cause the computing system to perform a method comprising:
determining a set of content sources that post content items relating to a first topic;
determining one or more content items that were posted by at least one content source in the set of content sources; and
providing an interface that references at least one topic channel corresponding to the first topic through which the one or more content items are accessible.

17. The non-transitory computer-readable storage medium of claim 16, wherein the set of content sources are selected by one or more curators.

18. The non-transitory computer-readable storage medium of claim 16, wherein determining the set of content sources that post content items relating to at least one topic further causes the computing system to perform:
clustering a plurality of content sources into one or more topic clusters; and
determining the set of content sources from a topic cluster that corresponds to the first topic.

19. The non-transitory computer-readable storage medium of claim 18, wherein a content source that posts a threshold amount of content items having at least one term that corresponds to the first topic is included in a topic cluster that corresponds to the first topic.

20. The non-transitory computer-readable storage medium of claim 16, wherein determining the set of content sources from the topic cluster that corresponds to the first topic further causes the computing system to perform:
determining a subset of content sources from the topic cluster using content sources that were selected from the topic cluster by one or more curators.
